(19) United States
(12) Patent Application Publication
(10) Pub. No.: US 2020/0021172 A1
(43) Pub. Date: Jan. 16, 2020

(54) CANLESS BRUSHLESS DC MOTOR

(71) Applicant: Superior Matching Concepts, Inc., Elkton, VA (US)

(72) Inventors: Jack Rimer, Elkton, VA (US); Philip Matthews, St-Hyacinthe (CA); Daniel Sullivan, Beauharnois (CA)

(21) Appl. No.: 16/033,857

(22) Filed: Jul. 12, 2018

(51) Int. Cl. H02K 15/02; H02K 1/12; H02K 5/00; H02K 15/14

(52) U.S. Cl. CPC H02K 15/02; H02K 15/14; H02K 5/00; H02K 1/12

(57) ABSTRACT

One embodiment provides a brushless DC motor, including: a mounting plate; an endbell; a rotor with a longitudinal axis; a stator with one or more passages and one or more legs extending inward from an outer portion of the stator; and one or more fasteners positioned substantially parallel to the longitudinal axis of the rotor, and passing through at least a portion of the mounting plate, one or more passages of the stator, and the endbell. Other aspects are described and claimed.

### BACKGROUND

Electric motors are electrical machines capable of converting electrical energy into mechanical energy. Typically, electric motors operate through an interaction between an electric motor's magnetic field and windings to generate a mechanical force. Electrical motors may be found in fans, blowers, pumps, household appliances, power tools, disk drives, transportation vehicles, toys, radio-controlled vehicles, or the like. Commutated DC motors may contain a set of rotating windings wound on an armature mounted on a rotating shaft. The shaft may have a commutator, or rotary electrical switch, that may periodically reverse the flow of current in the motor windings as the shaft rotates. Therefore, classic commutator DC motors may require brushes to contact a commutator.

### BRIEF SUMMARY

In summary, one aspect provides a brushless DC motor, comprising: a mounting plate; an endbell; a rotor with a longitudinal axis; a stator with one or more passages and one or more legs extending inward from an outer portion of the stator; and one or more fasteners positioned substantially parallel to the longitudinal axis of the rotor, and passing through at least a portion of the mounting plate, one or more passages of the stator, and the endbell.

Another aspect provides a method of manufacturing a brushless DC motor, comprising: manufacturing a mounting plate; manufacturing an endbell; manufacturing a rotor with a longitudinal axis; manufacturing a stator with one or more passages and one or more legs extending inward from an outer portion; and assembling the mounting plate, the endbell, the rotor, and the stator, with one or more fasteners positioned substantially parallel to the longitudinal axis of the rotor, and passing through at least a portion of the mounting plate, one or more passages of the stator, and the endbell.

A further aspect provides a brushless DC motor, comprising: a mounting plate; an endbell; a rotor with a longitudinal axis; a stator with one or more passages and one of more legs extending inward from an outer portion, wherein each of the one of more legs are offset with respect to the one or more legs; one or more fasteners positioned substantially parallel to the longitudinal axis of the rotor, and passing through at least a portion of the mounting plate, one or more passages of the stator, and the endbell; and one or more mounting means located on the mounting plate, wherein the one or more mounting means are located on a geometric chord of the mounting plate that does not pass through the center of the mounting plate.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 FRONT and FIG. 1 BACK illustrates a front view (FIG. 1 FRONT) and a back view (FIG. 1 BACK) of a canless motor assembly of an embodiment.

FIG. 2 illustrates an exploded view of a canless motor of an embodiment.

FIG. 3 STANDARD and FIG. 3 OFFSET illustrates a standard screw position (FIG. 3 STANDARD) and an offset screw position (FIG. 3 OFFSET) options of an embodiment.

FIG. 4 illustrates a keying of a mounting plate and an endbell into a stator of an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventional direct current (DC) electric motors convert electrical energy into mechanical energy. DC motors have a stationary set of magnets in the stator. The magnets are mounted on the inside surface of the can or casing of the motor. The motor also contains an armature with one or more windings of wire around a core to concentrate a magnetic field. Generally, an end of the windings connect to a commutator which is a rotary electrical switch that periodically reverses the current and which serves to energize each armature coil in turn, thereby causing rotation. For example, the rotation is caused by coils being electrically turned on and off in sequence to create a rotating magnetic field. The rotating magnetic fields interact with the magnetic fields of the magnets in the motor can to create a force on an armature causing rotation. Brushes connect the rotating coils with the external power supply. The brushes are in contact with a rotating commutator, and may be made of a soft material prone to wear and friction.

Brushed DC motors contain many disadvantages. Friction of the brushes against the commutator leads to power loss. The softer brush material wears down over time. This may require replacement or cleaning of the motor from dust and debris from the wearing of a brush. This maintenance means the motor may not be sealed thus limiting the number of applications for the motor. A resistance between the sliding brush on the commutator results in a “brush drop” consuming energy resulting in a lower performance of the motor. Also, abrupt current switching at the brush and commutator causes sparking which prevents use of the motor in an explosive atmosphere. The abrupt switching also creates electric noise which may create interference in electronic circuits.

Brushless motors use one or more permanent magnets which rotate around a fixed armature. The brush and commutator are substituted with an electronic controller, thereby reducing sparks, energy loss, friction, maintenance, and the like. Additionally, brushless motors are more efficient than brushed motors, require less maintenance, produce less electrical noise, and may be used for a wider number of applications. However, even conventional brushless motor designs are still bulky and heavy. This is especially true for applications that require a small yet powerful motor in a small space or an application where weight is an issue. What is needed is a DC brushless motor that maintains proper performance with a lighter construction.

Accordingly, an embodiment provides a canless brushless DC motor. In an embodiment the motor may have a mounting plate, an endbell, a rotor, and a stator. The stator may have one or more passages. In an embodiment, one or more fasteners may pass through the mounting plate, the stator, and the endbell. Since the motor does not have a can to position or align the components, the one or more fasteners may provide a concentric alignment of the motor components. Also, since the motor does not have a can to provide structural support to the motor, the stator may be a structural component of the motor.

In an embodiment, the stator includes one or more legs that extend inward from an outer portion of the stator. In other words, the one or more legs may extend from an outer portion of the stator which may follow the outside of the motor towards the center of the motor. The one or more legs may have wire windings upon the legs, for example, around a neck portion of the legs. In an embodiment, to allow a greater winding of wire on the leg (e.g., more wire), the fasteners that pass through the components of the motor may be offset with respect to the leg portions of the motor. In an embodiment, the one or more legs may be or a size or a thickness to optimize the wire winding for maximum performance of the motor.

In an embodiment a mounting mechanism of the motor may be offset from the center of the motor such the motor may be mounted in an offset or lowered position. For example, traditional motors contain two mounting mechanisms such as screw holes. In traditional motors the screw holes are located on a geometric line that bisects the geometric center of the mounting plate. Accordingly, in a described embodiment, the one or more mounting mechanisms may be located in a geometric chord that does not pass through the geometric center of the mounting plate. For example, the mounting screw holes may be such that when the motor is mounted, the entire motor assembly is in a lower mounting position as compared to traditional motor mounting screw locations. The lowered motor position may reduce the center of gravity of a product using the motor, or improve design features of the product. For example, in the use of a remote controlled car, the lowered motor mounting position lowers the center of gravity of the car and provides for better handling and performance from the car.

The illustrated example embodiments will be best understood by reference to the figures. The following description is intended only by way of example, and simply illustrates certain example embodiments.

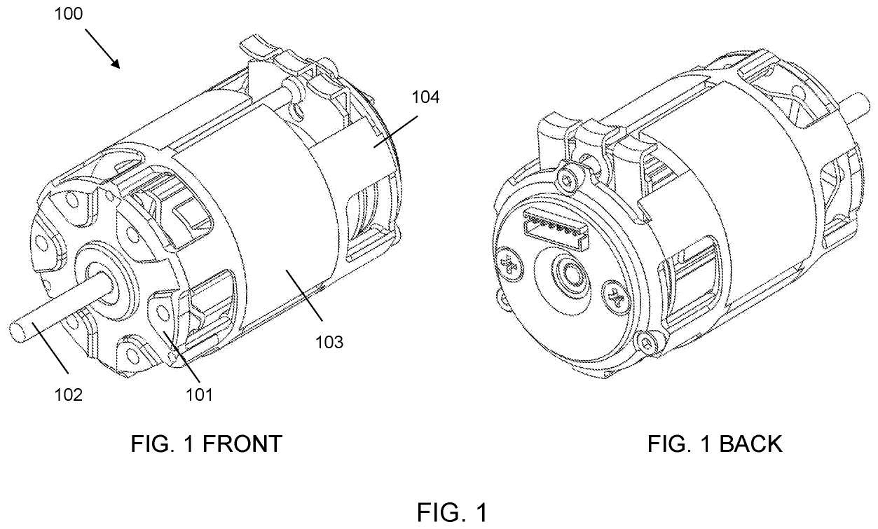

FIG. 1 FRONT illustrates an example embodiment of the motor in front view, and FIG. 1 BACK illustrates an example embodiment of the motor in back view. The terms “front” and “back” are merely used to denote a side for readability and understandability and it should be understood that these terms are not intended to be limiting. In an embodiment, a canless DC motor 100 may have a mounting plate 101 at a front end, and an endbell assembly (endbell) 104 at a back end. In an embodiment, the mounting plate 101 is located at the end of the motor 100 with a rotor 102 protruding, where the rotor 102 produces mechanical force. In an embodiment, the endbell 104 is located at the end of the motor 100 opposite of the shaft of the rotor 102. In other words, in an embodiment, the mounting plate 101 and the endbell 104 are at opposite ends of the motor 100.

In an embodiment each of the mounting plate 101 and the endbell 104 may have one or more apertures to allow the stator 103 to couple to the mounting plate 101 and the endbell 104. For example, in an embodiment, each of the mounting plate 101 and the endbell 104 may contain a bearing, a bushing, or the like, to receive a portion of the stator 103. The bearing, bushing, or the like, may reduce friction as the stator 103 rotates in the mounting plate 101 or the endbell 104. In an embodiment, the mounting plate 101 and endbell 104 are substantially circular in cross section. However, in an alternative embodiment, the mounting plate 101 and endbell 104 are not perfectly circular in cross section.

In an embodiment, a stator 103 may be disposed between the mounting plate 101 and endbell 104. In an embodiment, the stator 103 may be clamped between the mounting plate 101 and the endbell 104 through the assembly of the motor 100. In other words, after all the components of the motor 100 are assembled, the stator 103 may be positioned in a clamped-like position between the mounting plate 101 and the endbell 104. In an embodiment, one or more fasteners may provide mechanical force to affix and hold, during operation, the mounting plate 101 and the endbell 104 at ends of the stator 103 opposite one another. In an embodiment, the stator 103 may have one or more passages to allow the one or more fasteners to pass through the stator 103 so that the fasteners can reach and hold other components within the motor 100. Additionally, these passages within the stator 103 may be designed such that once the fasteners pass through the passages, the stator 103 will also be held by the fasteners. In other words, the stator passages may be designed to at least partially cover the fasteners while the fasteners are in position within the motor 100. In an embodiment, the mounting plate 101 and the endbell 104 may be concentric alignment with one another and may also be in concentric alignment with the stator 103.

The one or more fasteners pass through one or more passages of the stator. The one or more passages may run along the longitudinal axis of the stator. The passages may be notches or open to the outer wall of the stator. The passages may be holes enclosed on all sides. The passages may be a tube, sleeve, groove, slot, or the like, positioned longitudinally along the length of the stator. In an embodiment, one or more fasteners clamp the stator in position between the endbell and the mounting plate. In an embodiment, the one or more fasteners prevent the stator from rotating or spinning between the endbell and the mounting plate. In an embodiment, the one or more fasteners may fit snuggly in the lumen of the one or more passages. Alternatively, the one or more fasteners may have clearance around the fastener outer diameter and the inner diameter of the one or more passages.

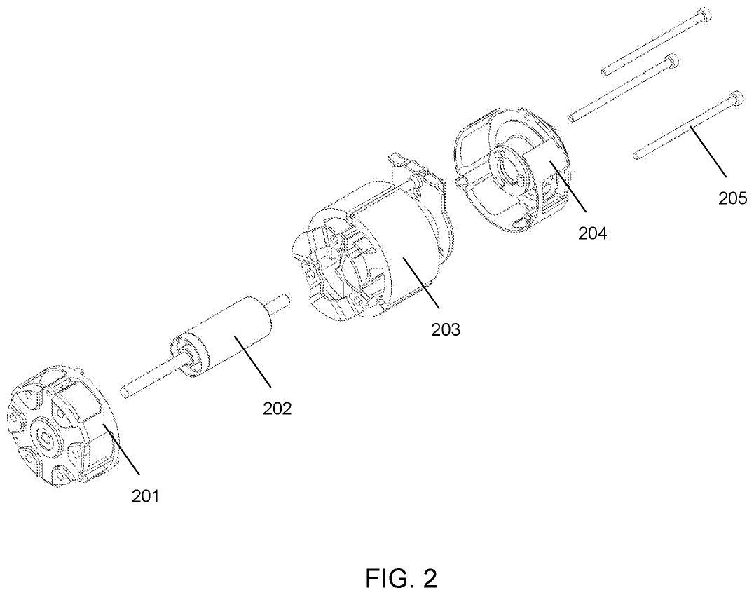

Referring to FIG. 2, an example embodiment of the motor is illustrated in an exploded view. In an embodiment, a mounting plate 201, a stator 202, and an endbell 204 are maintained in alignment using one or more fasteners 205. In an embodiment, the rotor 202 is held in place via an aperture in the mounting plate 201 and an aperture in the endbell 204. In an embodiment, the fasteners 205 may pass through the endbell 204, the stator 203, and the mounting plate 201, to hold these components in alignment with respect to one another. The one or more fastneners 205 may be screws, rivets, bolts, pins, or the like. The one or more fasteners 205 may be held in place by a threaded receiving aperture, a nut, a pin, by compression fitting, or the like.

The one or more fasteners 205 may fit tightly through aperture in the endbell 204 and the mounting plate 201. The fasteners 205 may fit either tightly or loosely through one or more passages in the stator 203. In other words, the fasteners 205 may pass through the stator 203 without touching the stator 203 or pass through a sleeve in the stator 203 that acts to hold the fastener 205. Additionally, one fastener passage of the stator 203 may hold the fastener passing through that passage tightly, while another fastener passage of the stator 203 may provide a loose fit around the fastener passing through that passage.

The one or more fasteners may have a shaft and a head with a means to receive a driving tool. For example, the head of the fastener may have a driving means such as a flat head, Philips head, hexagonal, hexilobular internal, or the like. The one or more fasteners may be inserted either from the mounting plate end or the endbell end of the motor, or may allow insertion from either end. Additionally or alternatively, one or more of the fasteners may be inserted from one end, while others of the fasteners are inserted from the other end, for example, in an alternating fashion. The one or more fasteners may include a threaded portion which may extend the entire length of the shaft of the fastener or which may only extend a portion of the fastener. In one embodiment, the threaded portion may be opposite the head end of the fastener. The position and number of the one or more fasteners with respect to the radial location may be selected based upon desired design and performance specifications of the motor.

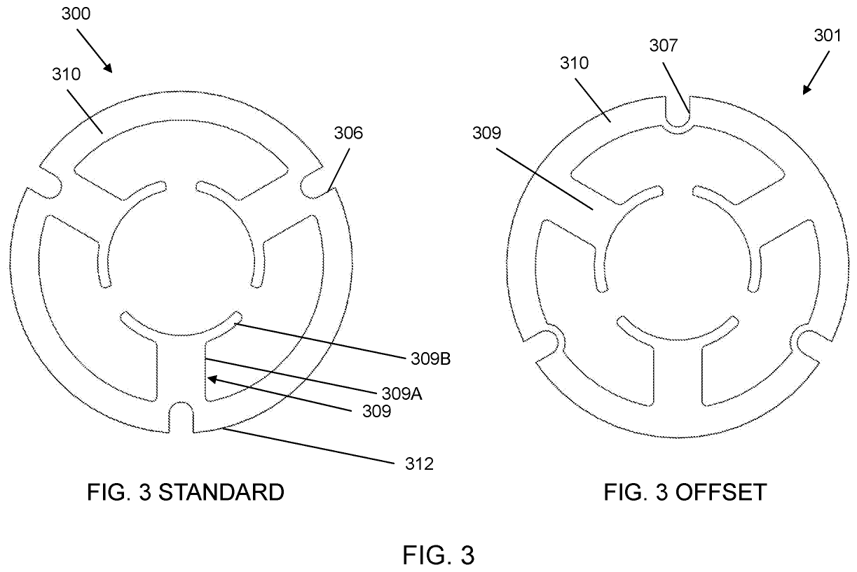

Referring to FIG. 3, two example illustrations of a cross section of a stator are shown. For reference, FIG. 3 shows a cross section of the illustrated element 203 of FIG. 2. In one embodiment, the passages of the stator that allow for the fastener to pass through the stator are in radial alignment with one or more legs of the stator. For example, FIG. 3 STANDARD illustrates one or more legs 309 in radial alignment with one or more passages 306 in the outer wall 310 of the stator 300. In an alternative embodiment, the passages that allow for the fasteners to pass through the stator are offset with respect to the legs of the stator. As another example, FIG. 3 OFFSET illustrates one or more legs 309 not in radial alignment with one or more passages 306 in the outer wall 310 of the stator.

In an embodiment, electrically conductive wire is wound around each of the one or more legs. These wires may be referred to as windings. For example, the windings may be positioned around a neck of the legs. Using FIG. 3 STANDARD as an example for explanation, the neck 309A of the leg 309 would be the portion of the leg between the outer portion of the stator 312 and the foot 309B of the leg. This would also be applicable to the stator illustrated in FIG. 3 OFFSET. In an embodiment, the leg may be “thinned out”, for example, having a thinner neck 309A portion in a width direction with respect to the view in FIG. 3 STANDARD, having a thinner neck 309A portion in a depth direction with respect to the view in FIG. 3 STANDARD (not shown in FIG. 3 STANDARD), or the like, to minimize the length of wire that may be coiled around the one or more legs.

Also with a thin leg and thinner outside wall, there may not be much material left, which creates another issue that when the fastener is inserted in over top of leg, and the coil is wound around leg, the coil starts to touch where the fastener passes through the stator. Thus, in an embodiment, and as illustrated in FIG. 3 OFFSET, the fastener passage is moved 60 degrees around the radius of the circumference of the stator to an offset position. Therefore, in an embodiment, material may be added where previously removed or thinned out in a standard configuration. In an embodiment this results in a structurally stronger motor with better magnetic properties. For example, there may be more steel (or like material) above the coil. For example, there are no restrictions or impingements with the coil itself interfering with fasteners or fastener passages. In other words, the fastener passages are shifted to design a stronger more powerful motor.

In an embodiment, no can may be required on top of the stator. For example, a can may not be needed as opposed to traditional brushless motors which require the can to attach a mounting plate (and associated front bearing) or endbell (and associated rear bearing) with a control board. Without the can, as in the motor described herein, a material thickness around the one or more passages for a fastener may be increased. For example, if a motor does not have a can, the magnetic flux may not be uniform as the rotor rotates with respect to the stator. Thus, the thickness of material around the passages (i.e. screw hole around screws) may provide a more uniform magnetic field for the motor.

In an embodiment, the one or more legs may not extend at right angles radially inward from the outer wall or outer portion of the stator. In other words, the one or more legs may be swept with respect to the outer portion of the stator. The legs may be swept forward or swept reverse with respect to the rotational direction of the rotor of the motor. In an embodiment, each of the one or more legs may be at the same angles or at different angle with respect to the outside wall of the stator. Additionally or alternatively, the legs may be of a shape to allow a coil to be wrapped around a leg in non-circular fashion. In other words, the one or more legs may be of a shape such that the coil wrapped around the leg may have an oblong, ovoid, egg-shaped, elliptical, or the like, shape in cross section. The non-circular coils may improve the magnetic properties of the motor.

The motor may be a smaller diameter to work within regulations of a radio controlled sanctioning body (i.e. Remotely Operated Auto Racers (ROAR) Dallas, Tex.). Different embodiments of the motor may be offered for different sanctioning bodies, or for changes to current sanctioning body regulations. The specifications listed are exemplars and other embodiments are disclosed. One such example follows. The motor may be 34 mm in diameter. The mounting means may be offset such that the motor may sit in an offset or “lowered” position with respect to the entire product in which the motor may be placed, such as the chassis of a radio-controlled car or the like. This offset and lowering of the motor within a vehicle may be referred to as a LowRider Motor. In an embodiment, the motor may be lowered by about 1 mm. The offset mounting motor may be referred to as a LowRider 540-2 Pole Modified Motor. The overall length of the motor may be shortened to sanctioning body rules. The smaller diameter, shorter motor that is canless may reduce weight by about 17%. A sensor board may be positioned to allow the assembly to sit flat and/or square to the rotor shaft. The end-bell and mounting cap may be locked into the stator. This locking may assure bearing alignment and/or reduce vibration in the operation of the motor.

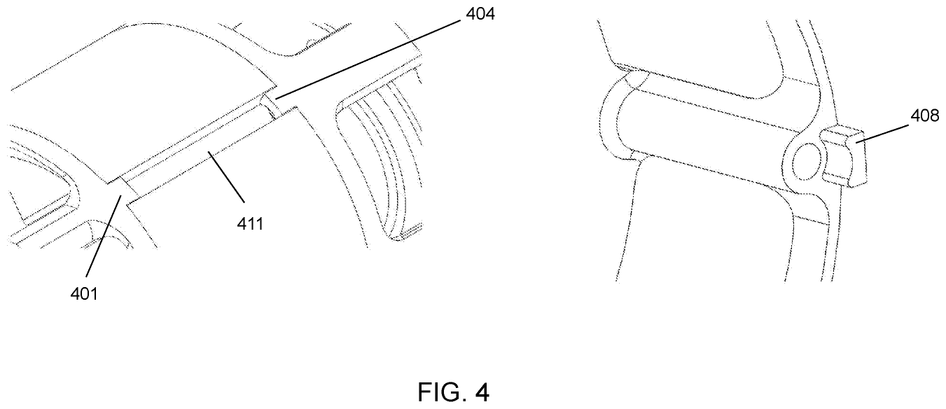

Referring to FIG. 4, an example embodiment illustrates screw slot passage 411 as a fastener passage. One of more fasteners may pass through a passage in the stator. For example, the fastener may be a screw and the passage may be a screw slot. Examples are not meant to be limiting and other fastener and passages are contemplated and disclosed.

In an embodiment, a mounting plate may include a mounting plate tab 401 that “keys” into a complementary slot on a passage of the stator 411. In an embodiment, an endbell may include an endbell tab 404 that “keys” into a complementary slot on a passage of the stator 411. In an embodiment, the tab may be on the stator and “key” into a slot on an endbell or a mounting plate. A tab may serve to prevent the rotation of the stator that is clamped between the endbell and an endplate. The example of a tab “keying” into a passage is an illustrative example.

In an embodiment, the stator may have a complimentary surface to the endbell to align the stator and the endbell. In an embodiment, the stator may have a complimentary surface to the mounting plate to align the stator and the mounting plate. In an embodiment, the complementary surfaces may include tabs, indentations, ridges, grooves, or the like, to mate complementary surfaces together and provide alignment. The complementary surfaces may prevent rotation of the stator with respect to the endbell and/or the mounting plate. The one or more fasteners may clamp the stator in between the endbell and the mounting plate. In an embodiment, the tightening or clamping forces of the one or more fasteners hold the stator in a position between the endbell and the mounting plate, and/or the complimentary surfaces between the stator and endbell or mounting plate, and provides a motor design without a can or outer shell.

In an embodiment, the mounting means may be offset such that the motor may sit in an offset or “lowered” position with respect to the entire product. For example, traditional motors typically have a mounting means such as two threaded holes through which a threaded fastener may pass through a plate on a product and thread into the motor. In these traditional motors, these mounting means or threaded holes may be positioned along a line that passes through the geometric center point of the cross sectional area of the end of the motor mounting to a product. In an embodiment of the described motor, one or more mounting means may be located on a geometric chord not passing through the geometric center point of the cross sectional area of the end of the motor. In other words, the mounting means may not be along a line demarcating the diameter of the cross sectional area (substantially circular). A mounting means not located on the diameter of the circular cross section leads to an offset mounting means. An offset mounting means may position the motor in a position that provides an advantageous configuration. For example, if the motor is to be mounted in a moving vehicle or toy, the motor may be lowered in the vehicle or toy such that the center of gravity is lowered. A lower center of gravity provides greater stability for the vehicle or toy.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A brushless DC motor, comprising:
a mounting plate;
an endbell;
a rotor with a longitudinal axis;
a stator with one or more passages and one or more legs extending inward from an outer portion of the stator; and
one or more fasteners positioned substantially parallel to the longitudinal axis of the rotor, and passing through at least a portion of the mounting plate, one or more passages of the stator, and the endbell.

2. The brushless DC motor of claim 1, further comprising one or more windings on the one or more legs.

3. The brushless DC motor of claim 1, wherein each of the plurality of the passages is radially aligned with respect to the plurality of legs.

4. The brushless DC motor of claim 1, wherein each of the plurality of the passages is radially offset with respect to the plurality of legs.

5. The brushless DC motor of claim 1, wherein each of the plurality of legs is narrow in cross section with respect to the longitudinal axis of the motor.

6. The brushless DC motor of claim 1, wherein each of the plurality of legs extends inward from an outer portion of the stator at other than a right angle.

7. The brushless DC motor of claim 1, the endbell further comprising one or more tabs that align the endbell with other components of the brushless DC motor.

8. The brushless DC motor of claim 1, wherein the one or more fasteners are selected from the group consisting of screws, bolts, rivets, pins, and clamps.

9. The brushless DC motor of claim 1, wherein the motor is not fully enclosed by a can.

10. The brushless DC motor of claim 1, further comprising one or more mounting mechanisms located on the mounting plate, wherein the one or more mounting mechanisms are located on a geometric chord not passing through the center of the diameter of the motor.

11. A method of manufacturing a brushless DC motor, comprising:
manufacturing a mounting plate;
manufacturing an endbell;
manufacturing a rotor with a longitudinal axis;
manufacturing a stator with one or more passages and one or more legs extending inward from an outer portion; and
assembling the mounting plate, the endbell, the rotor, and the stator, with one or more fasteners positioned substantially parallel to the longitudinal axis of the rotor, and passing through at least a portion of the mounting plate, one or more passages of the stator, and the endbell.

12. The method of manufacturing of claim 11, further comprising one or more windings on the one or more legs.

13. The method of manufacturing of claim 11, wherein each of the plurality of the passages is radially aligned with respect to the plurality of legs.

14. The method of manufacturing of claim 11, wherein each of the plurality of the passages is radially offset with respect to the plurality of legs.

15. The method of manufacturing of claim 11, wherein each of the plurality of legs is narrow in cross section with respect to the longitudinal axis of the motor.

16. The method of manufacturing of claim 11, wherein each of the plurality of legs extends inward from an outer portion of the stator at other than a right angle.

17. The method of manufacturing of claim 11, the endbell further comprising one or more tabs that align the endbell with other components of the brushless DC motor.

18. The method of manufacturing of claim 11, wherein the motor is not fully enclosed by a can.

19. The method of manufacturing of claim 11, further comprising one or more mounting mechanisms located on the mounting plate, wherein the one or more mounting mechanisms are located on a geometric chord not passing through the center of the diameter of the motor.

20. A brushless DC motor, comprising:
a mounting plate;
an endbell;
a rotor with a longitudinal axis;
a stator with one or more passages and one of more legs extending inward from an outer portion, wherein each of the one of more legs are offset with respect to the one or more legs;
one or more fasteners positioned substantially parallel to the longitudinal axis of the rotor, and passing through at least a portion of the mounting plate, one or more passages of the stator, and the endbell; and
one or more mounting means located on the mounting plate, wherein the one or more mounting means are located on a geometric chord of the mounting plate that does not pass through the center of the mounting plate.
